(19) United States
(12) Patent Application Publication
(10) Pub. No.: US 2008/0278758 A1
(43) Pub. Date: Nov. 13, 2008

(54) Image processing system, computer program product, and image processing method

(75) Inventor: Yoshifumi Sakuramata, Tokyo (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/149,330

(22) Filed: Apr. 30, 2008

(30) Foreign Application Priority Data
May 10, 2007 (JP) 2007-125863

(51) Int. Cl. G06K 15/00

(52) U.S. Cl. 358/1.18

(57) ABSTRACT

Upon receipt of a set of original data in different formats, data analysis information for the original data is generated. Based on the data analysis information, the formats of the original data is automatically adjusted to a uniform output format selected by a user. The original data are output in the output format desired by the user.

### CROSS-REFERENCE TO RELATED APPLICATIONS

The present application claims priority to and incorporates by reference the entire contents of Japanese priority document 2007-125863 filed in Japan on May 10, 2007.

### BACKGROUND OF THE INVENTION

1. Field of the Invention

The present invention relates to an image processing system, a computer program product, and an image processing method.

2. Description of the Related Art

In recent years, various functions are available in image processing apparatuses such as copiers, facsimile machines, printers, and multifunction products (MFPs) that combine any or all functions of these.

In such a conventional image processing apparatus, a user can specify settings of various functions such as those concerning state of an original including the type and density of the original, those concerning image processing including expansion/reduction ratio, simplex/duplex printing, and margin size, and those concerning finishing including stamping, stapling, and punching.

However, in the conventional image processing apparatus, when such settings are specified for printing, finished state cannot be checked until a print result is output. For example, if positions of the punch holes overlap an image in finished state, a user does not notice it until the image is output (printed). This results in misprinting and waste of sheets.

Japanese Patent Application Laid-Open No. 2001-67347 discloses an image processing apparatus that can display, prior to actual printing, a preview image of a print result obtained by applying processing of various functions such as a finish function (print sheet designation, print side designation, punching, stapling, etc.) to a pre-scanned original image. Thus, a user can change print settings when necessary while viewing the preview image.

The applicant of this application has proposed, in Japanese Patent Application Laid-Open No. 2006-003568, an intuitive and highly convenient user interface in which, when a user touches a specific position in a preview image of an original, a menu related to the position is displayed so that the user can select a desired item from the menu. Examples of items of the menu include print sheet, print side, punching, stapling, output color, output density, sheet, expansion/reduction, simplex/duplex printing, combination printing, sort/stack. Upon selection of an item from the menu, setting corresponding to the item is immediately reflected in the preview image.

When data is received from an external device such as a personal computer and subjected to print processing in an image processing apparatus, a user may desire to output data in a plurality of formats for different applications in a bound form. In such a case, the user starts the respective applications for output setting and printing, and binds the data into one by stapling or the like.

However, when the user makes a mistake in print setting in the respective applications, a format of a print changes for each data (i.e., for each page). In particular, in an application for handling image data, when a data area is small compared with a size of a print sheet, a useless blank space is left in the print sheet. On the other hand, when a data area is larger than a size of a print sheet (e.g., when a large table is printed by a spreadsheet application), a necessary section is divided or is not output.

### SUMMARY OF THE INVENTION

It is an object of the present invention to at least partially solve the problems in the conventional technology.

According to an aspect of the present invention, there is provided an image processing system including an input unit that receives a set of original data in a plurality of formats; an analyzing unit that analyzes the original data to generate analysis information for the original data; a format display unit that selectably displays output formats for the original data; a selecting unit that allows selection of one of the output formats; an adjusting unit that adjusts, based on the analysis information, the formats of the original data into a uniform output format selected by the selecting unit; and an output unit that outputs the original data in the uniform output format.

According to another aspect of the present invention, there is provided an image processing method including receiving a set of original data in a plurality of formats; analyzing the original data to generate analysis information for the original data; selectably displaying output formats for the original data; selecting one of the output formats; adjusting, based on the analysis information, the formats of the original data into a uniform output format selected at the selecting; and outputting the original data in the uniform output format.

According to still another aspect of the present invention, there is provided a computer program product that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of an image forming system according to an embodiment of the present invention;

FIG. 2 is an example of a preview image;

FIG. 3 is an example of a preview image in which a setting item is selected;

FIG. 4 is an example of an association table of setting items and positions where the respective setting item can be set;

FIG. 5 is an example of a preview image subjected to punching;

FIG. 6 is a flowchart of format unifying processing performed under the control of a system control unit shown in FIG. 1;

FIG. 7 is an example of an input screen on which a list of output formats are displayed;

FIG. 8 is an example of a conversion table T1;

FIG. 9 is an example of a conversion table T2;

FIG. 10 is another example of a preview image;

FIG. 11 is an example of an output adjustment table.

### DETAILED DESCRIPTION OF THE PREFERRED EMBODIMENTS

Exemplary embodiments of the present invention are explained in detail below with reference to the accompanying drawings.

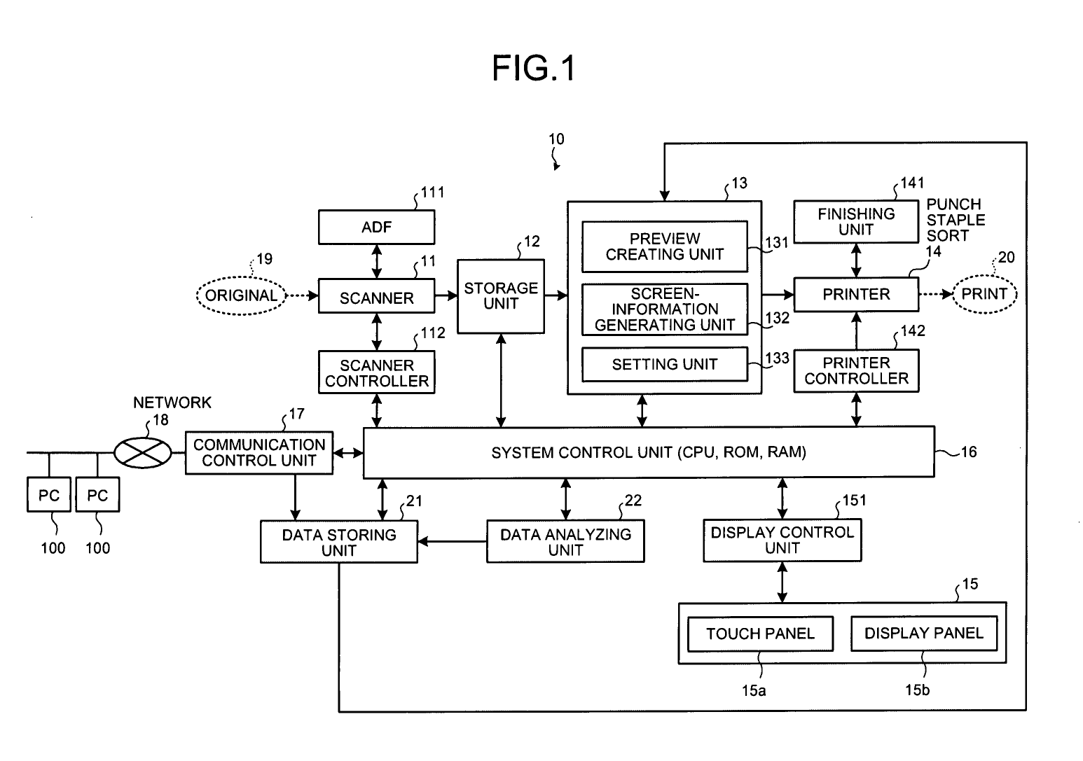

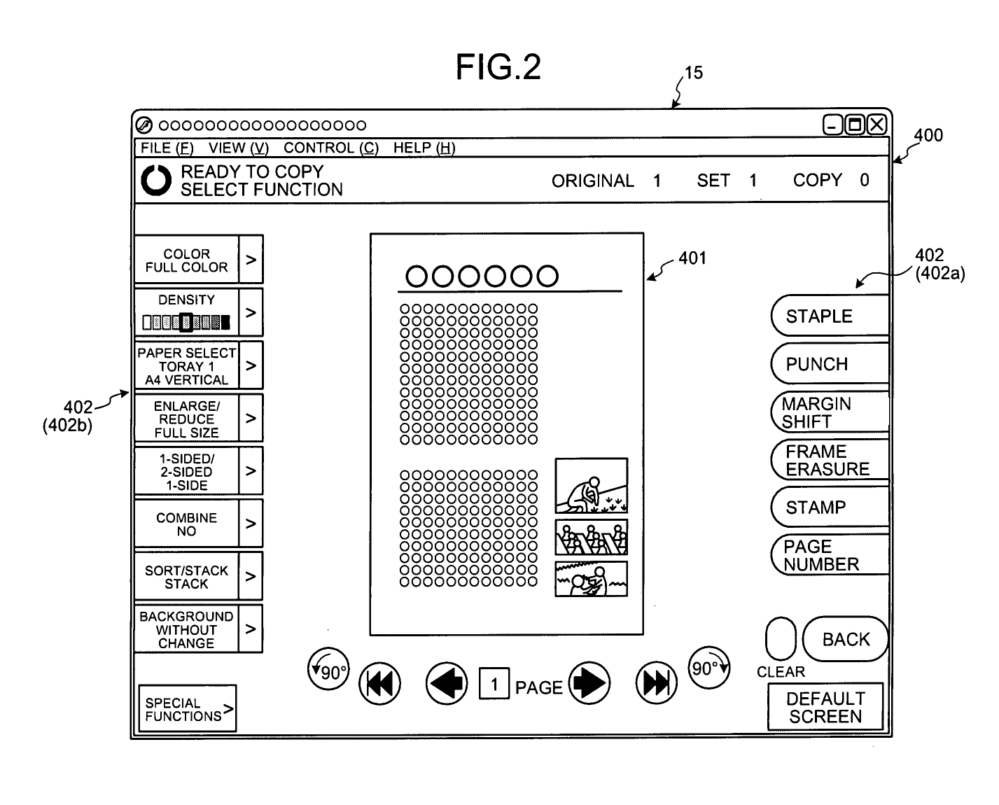

An embodiment of the present invention is explained referring to FIGS. 1 to 12. An image forming system is explained below as including an external device such as a personal computer and, for example, a multifunction product (MFP) that combines any or all of such functions as a copier, a facsimile (FAX) machine, a printer, a scanner, and a function of delivering an input image (an original image scanned by the scanner or an image input by the FAX machine), which are connected via a network.

FIG. 1 is a functional block diagram of an MFP 10 according to the embodiment. The MFP 10 includes a scanner 11, an automatic document feeder (ADF) 111, a scanner controller 112, a storage unit 12, an image processing unit 13, a printer 14, a printer controller 142, a finishing unit 141, a display unit 15, a display control unit 151, a system control unit 16, a communication control unit 17, and an image analyzing unit 21. The MFP 10 is connected to a network 18 via the communication control unit 17. The MFP 10 scans an image of an original 19, applies image processing to the image, and outputs the image as a print 20.

The system control unit 16 is connected to the respective units and controls the MFP 10. For example, the system control unit 16 provides the scanner 11 with scanning area information appropriate for a selected sheet size. The system control unit 16 includes a central processing unit (CPU), a read only memory (ROM), and a random access memory (RAM). The CPU executes a computer program stored in the ROM using a work area of the RAM, thereby performing various types of processing.

The computer program executed on the MFP 10 can be stored in a computer readable recording medium such as a compact disk-read only memory (CD-ROM), a flexible disk (FD), a compact disk-recordable (CD-R), or a digital versatile disk (DVD) as a file of an installable format or an executable format. In this case, the CPU of the system control unit 16 loads the computer program from the recording medium into a main storage (not shown) and execute it, thus implementing various functions of the MFP 10. The computer program can be stored in a computer connected via the network 18 such as the Internet, and downloaded therefrom. The computer program can also be distributed through the network 18.

The communication control unit 17 is connected to a network such as a local area network (LAN) or the Internet and exchanges image data, control data, and the like with other apparatuses connected to the network according to a communication protocol. In other words, the communication control unit 17 has functions of inputting and outputting an image.

The scanner controller 112 receives a command from the system control unit 16 and controls the scanner 11.

The scanner 11 is controlled by the scanner controller 112 and converts an image of the original 19 into digital image data. The ADF 111 sequentially delivers a plurality of pages of originals set thereon to a scanning position of the scanner 11 one by one. Thus, the scanner 11 can automatically and sequentially scan the originals. The ADF 111 can deliver not only an original printed on one side thereof but also an original printed on both sides thereof by reversing the original. Thus, it is possible to cause the scanner 11 to scan the both sides of the original.

The storage unit 12 is a buffer memory that receives a command from the system control unit 16 and temporarily stores therein image data scanned by the scanner 11, image data received from the outside through the network 18, and the like. The MFP 10 can process image data received from the outside through the network 18 as well as image data scanned by the scanner 11 to form an image. The storage unit 12 also stores therein image data processed by the image processing unit 13.

The image processing unit 13 receives a command from the system control unit 16, applies γ correction, modulation transfer function (MTF) correction, and the like to multi-value data sent from the scanner 11 and temporarily stored in the storage unit 12. The image processing unit 13 performs gradation processing such as slicing and dithering on the data, and converts it to digital (multi-value) data. The image processing unit 13 performs various kinds of image processing (reduce/enlarge, adjustment of density and colors, etc.) corresponding to functions set by a user, image-area edit (area erasure, area movement, area reversal, etc.), and layout processing (duplex/simplex printing, image combining, margin adjustment, etc.). Thus, the image processing unit 13 creates a preview image indicating a finished state of an image.

The image processing unit 13 includes a preview creating unit 131, a screen-information generating unit 132, and a setting unit 133.

Basically, the preview creating unit 131 creates a preview of the original image (a preview image) based on settings or parameters specified for processing image data obtained by pre-scanning an original image and displayed on a display panel 15b. The preview creating unit 131 uses the multi-value data temporarily stored in the storage unit 12.

The screen-information generating unit 132 generates input screen information displayed on the display panel 15b. The input screen information includes the preview image and various types of setting items for the preview image created by the preview creating unit 131.

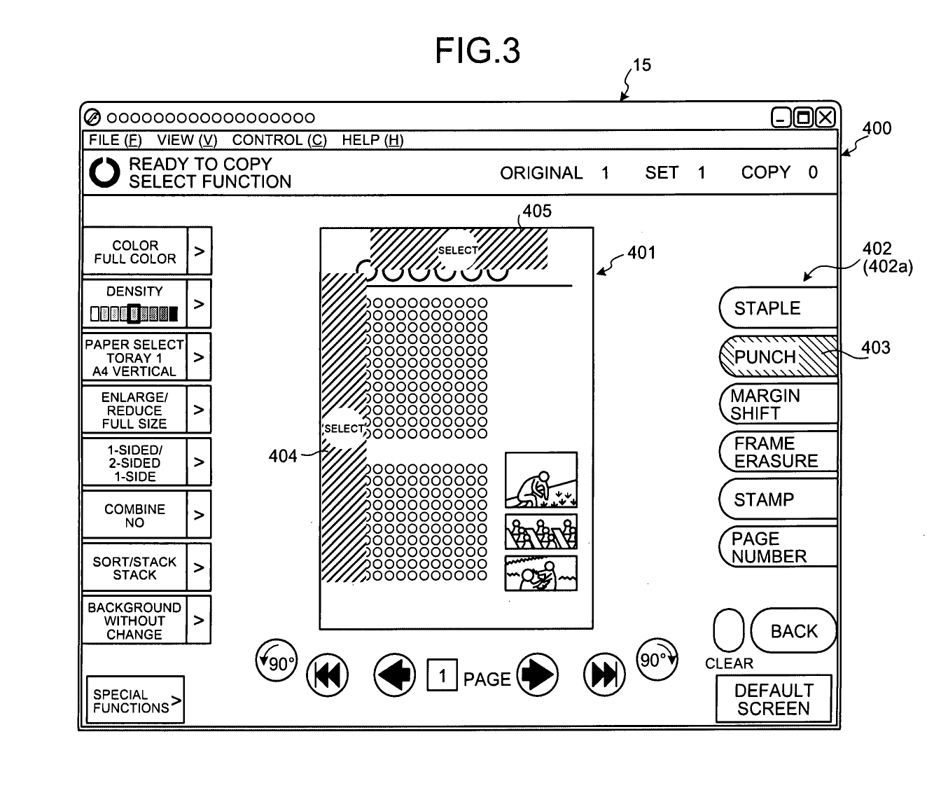

When the user provides setting input on an input screen 400 (refer to FIG. 3) displayed on the display panel 15b through a touch panel 15a, described later, the setting unit 133 receives a signal of the setting input and acquires coordinate information concerning an input image stored in the storage unit 12. The setting unit 133 sets processing corresponding to the acquired coordinate information in the screen-information generating unit 132.

When the setting unit 133 receives a setting input signal, the preview creating unit 131 updates and creates a preview image again according to the setting input signal and outputs the preview image to the screen-information generating unit 132. The screen-information generating unit 132 generates input screen information to display a screen for receiving a setting input from the user again according to the setting input signal received by the setting unit 133, and outputs the input screen information to the display control unit 151.

The display control unit 151 receives a command from the system control unit 16 and controls input and output of the display unit 15. For example, the display control unit 151 controls to output data processed by the image processing unit 13 to the touch panel 15a and the display panel 15b. More specifically, the display control unit 151 causes the display panel 15b to display a preview image. The display control unit 151 controls input from the touch panel 15a. The display panel 15b and the touch panel 15a are separately shown in FIG. 1; however, they are explained as being integrated in the following description.

The touch panel 15a detects a position with which a pointer makes an electric or magnetic contact. As pointing means (not shown) for pointing a position on the touch panel 15a, a finger tip, a stylus pen, and other touch input tools (hereinafter, “pointers”) can be used. The user inputs various settings or parameters including print setting by touching the touch panel 15a with such a pointer.

In this embodiment, an example is explained in which input is provided by touching the touch panel 15a. However, input can be provided in other manners. For example, the display unit 15 can include a hard key (physical key) that a user presses to issue a command such as a print command. As the display panel 15b, a dedicated display device included in the MFP 10 can be used.

The display unit 15 displays functions available in the MFP 10 as setting items and receives from the user setting input indicating a setting item selected from the setting items. When a user touches with the pointer a position on the touch panel 15a, a coordinate of the position is detected. When the position is in an area corresponding to a setting item (where the setting item is selectable), the display control unit 151 determines that the setting item is selected. For example, the display unit 15 receives setting of scanning conditions for the scanner 11 corresponding to the state of an original, setting for the image processing unit 13 that performs processing such as image quality adjustment on scanned image data, setting of print conditions for the printer 14, and setting for the finishing unit 141 that applies finishing such as sorting, stapling, and punching to a print after printing.

The printer controller 142 controls the printer 14 in response to a command from the system control unit 16.

The printer 14 is mounted with the finishing unit 141. The finishing unit 141 performs finishing, based on automatic setting or setting specified by the user, such as sorting, by a unit of the number of copies or a page, the print 20 obtained by printing, stamping a predetermined stamp on a print medium, aligning a plurality of print media and stapling the print media, and punching punch holes for binding the print media in a binder or a file.

Upon receiving a setting as described above via the display control unit 151, the system control unit 16 causes the image processing unit 13 to create a preview image by reflecting the setting on the original image data stored in the storage unit 12. The system control unit 16 sends the preview image to the display unit 15 such that the display unit 15 displays the preview image.

FIG. 3 is an example of a preview image created by the preview creating unit 131 from input image data. A preview image 401 and setting items 402 are displayed on the display panel 15b. As the setting items 402, a menu 402a related to positions or an original direction on the preview image 401 including items such as staple, punch, margin shift, frame erasure, stamp, and page number is displayed on the right side of the screen. On the left side of the screen is displayed menu 402b not related to contents of image data, such as an output color, output density, sheet, reduce/enlarge, simplex/duplex, combination, sort and stack, and background. In other words, the menu 402b includes setting items for functions that can be specified without checking an original image.

When the user touches the touch panel 15a with the pointer while viewing the preview image 401 displayed on the display panel 15b, the touch panel 15a receives input of positional information concerning a spatial position on a print in a finished state displayed as the preview image 401. In such a case, the setting unit 133 analyzes the positional information received through the touch panel 15a and acquires coordinate information indicating a position or points on an image touched by the pointer.

The data storage unit 21 stores therein original data received from an external device or the like such as a personal computer 100 via the communication control unit 17. The original data includes not only data of an original image but also a file name accompanying the data, an extension name for distinguishing an application in use, a data format, and device information indicating a device that has read the data. The original data also includes sheet size, combination printing instruction, magnification, and margin setting accompanying an output command from an application or an operating system (OS).

The data analyzing unit 22 performs data analysis processing on original data stored in the data storage unit 21. Specifically, the data analyzing unit 22 analyzes a file name accompanying data, an extension name, a data format, device information indicating a device that has read the data, sheet size, combination printing instruction, magnification, margin setting, and the like.

With this structure, the MFP 10 displays, prior to printing, the preview image 401 on the display panel 15b. After checking the preview image 401 visually, the user can change the setting when necessary and perform printing.

More specifically, copying can be reliably performed by a series of processes: (1) pre-scanning an original, (2) displaying an image of the original pre-scanned on a screen as a preview image, (3) when a user touches a predetermined position on the preview image, displaying a menu of functions corresponding to the position, (4) when the user selects one of the functions, immediately reflecting the function in the preview image, and, (5) after checking the update preview image on the screen, starting printing.

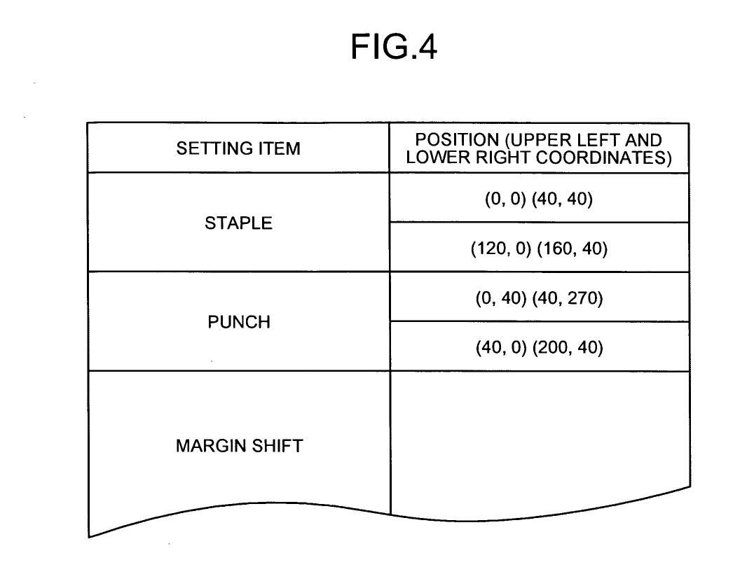

As shown in FIG. 4, it is assumed that punch 403 is selected from the setting items 402 (the menu 402a) displayed on the display unit 15 by touch input from the user.

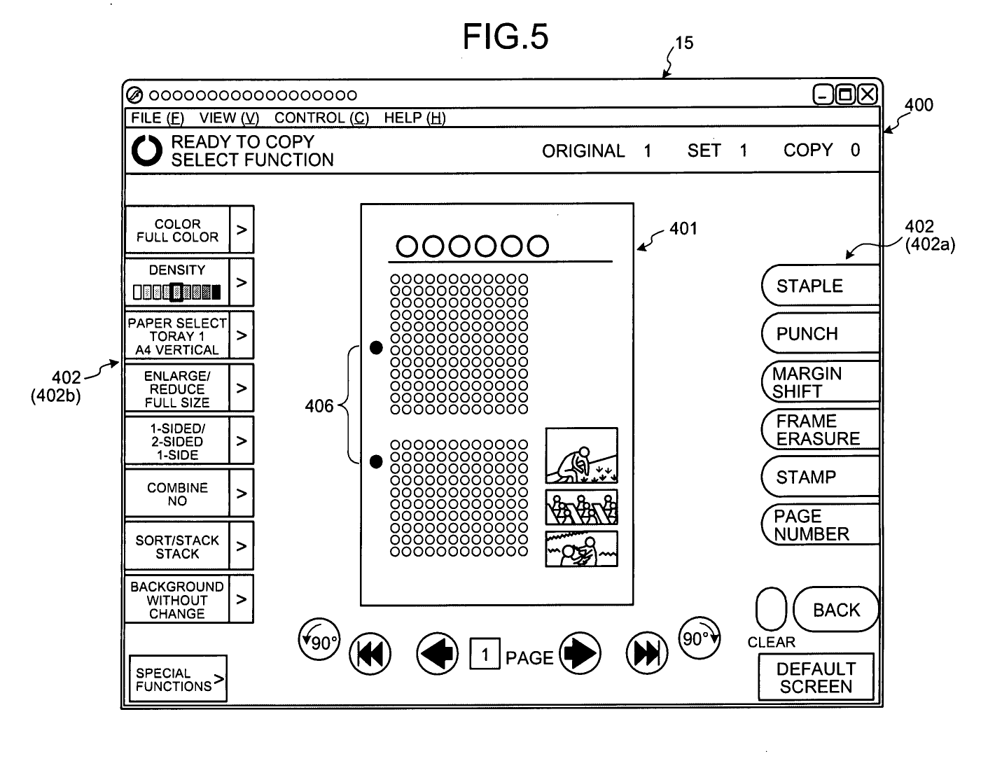

When the display unit 15 detects a touch on the punch 403 displayed thereon, the system control unit 16 receives setting of the punch 403 via the display control unit 151. The screen-information generating unit 132 reads out an area corresponding to the punch 403 from an association table. In the association table, as shown in FIG. 5, functions corresponding to the setting items 402 are associated with areas where the functions is to be applied. The screen-information generating unit 132 displays areas 404 and 405 where the punch 403 can be applied on the display unit 15. Such an association table is stored in RAM or the like of the system control unit 16. The areas 404 and 405 where punch holes can be opened can be displayed on the preview image 401 in an overlaid manner. The areas 404 and 405 can also be displayed with a different color, as being blinking, or with other areas darkening out. The areas indicated by the association table shown in FIG. 5 are defined by a rectangle having sides parallel in main scanning and sub-scanning directions, respectively, defined by diagonal lines each connecting two points defined by coordinates. For example, an area for “staple” is defined by a line from (0,0) to (40,40) and a line from (120,0) to (160,40).

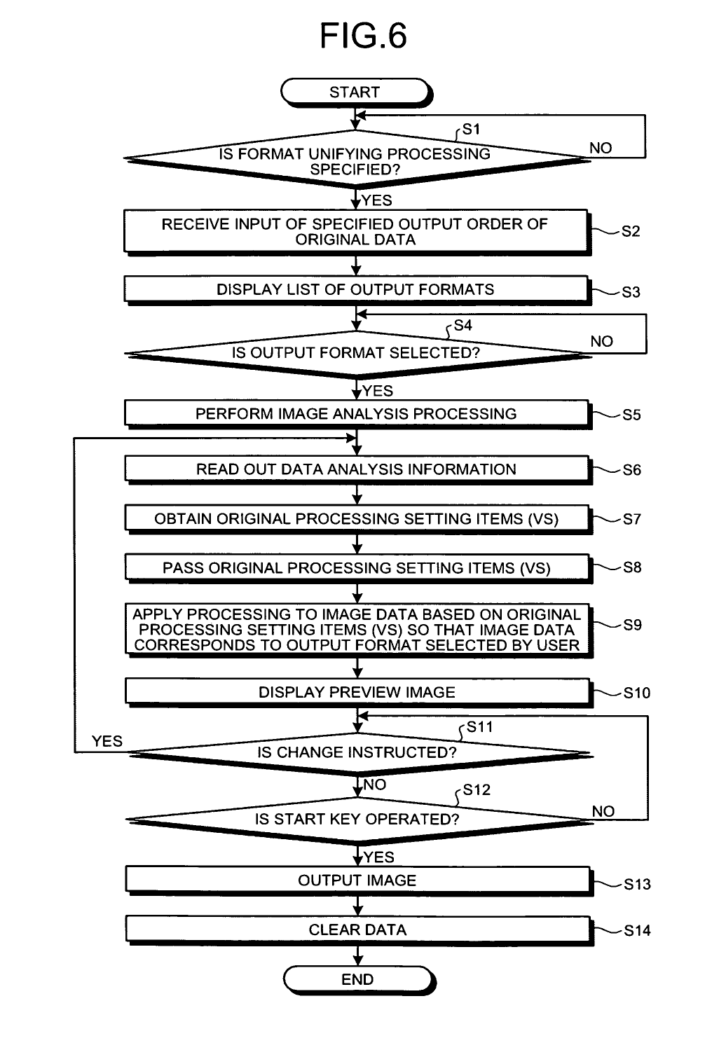

The user provides touch input by touching the punch hole area 404 shown in FIG. 4. The display unit 15 receives the touch input on the punch 403. The preview creating unit 131 creates a preview image by reflecting the setting for applying punching in the area, sends the preview image to the display unit 15. Accordingly, the display unit 15 displays the preview image. The preview image 401 subjected to punching 406 is shown in FIG. 6. Setting input such as correction is received through the preview image 401 displayed in this way. The setting is reflected and displayed again. When there is no setting input, printing is performed.

Although not shown, when the user touches a specific position on the preview image, a menu of functions related to the position can be displayed, such that when a user selects one of the functions, the effect of the function can be immediately reflected in the preview image.

Incidentally, according to this embodiment, the MFP 10 can bind or consolidate original data in a plurality of formats for different applications received from an external device such as the personal computer 100 into one, and output the original data in a bound form.

Format unifying processing is performed under the control of the system control unit 16 (the CPU of the system control unit 16 operating based on the computer program stored in the ROM). The format unifying processing is explained below referring to FIG. 6.

As a precondition for the format unifying processing, the user needs to select several sets of original data present on the personal computer 100, send the selected original data to the data storage unit 21 of the MFP 10 via a printer driver to store the original data therein. The original data can be sent to the data storage unit 21 by drag and drop using the printer driver.

As shown in FIG. 6, the system control unit 16 determines that format unifying processing is specified by predetermined key operation on the display unit 15 (Yes at step S1). Then, the system control unit 16 receives specified output order in which original data is to be output, and stores the output order in the data storage unit 21 as a management sequence for the original data (step S2). This is because, when the user desires to bind or consolidate the original data into one, the user needs to designate a delimiter for one data and order of the original data. With this, it is possible to set one print unit. As the output order of the original data can be specified, for example, the order in which the user touches icons of a plurality of original data displayed on the display unit 15.

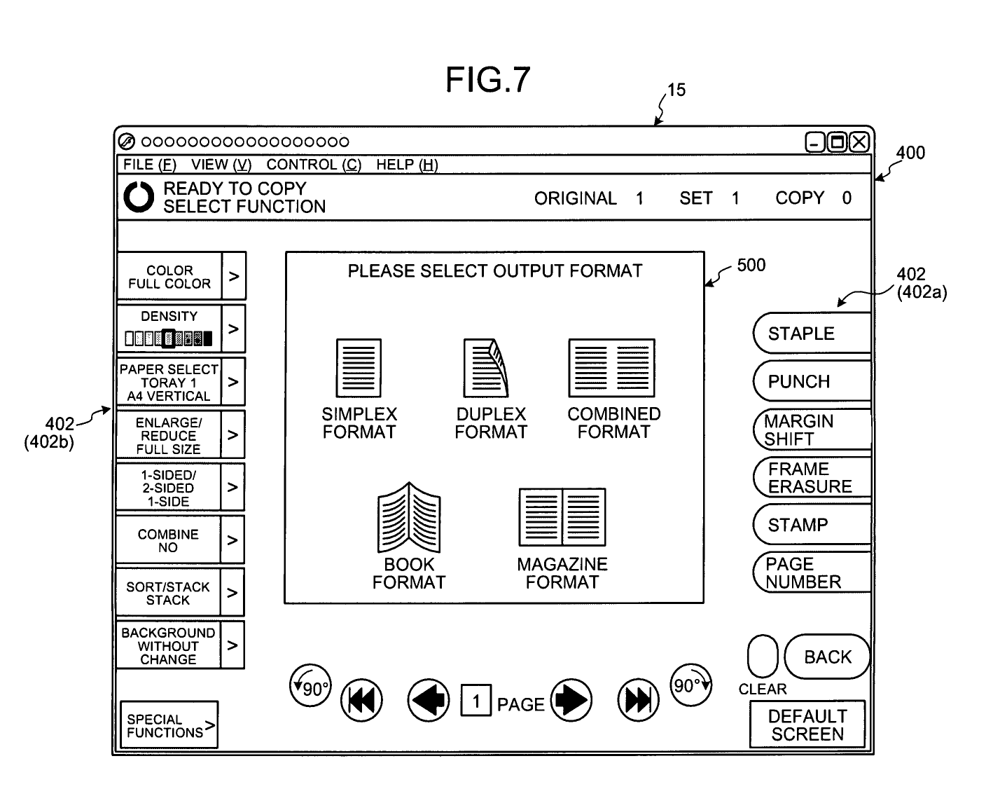

After receiving the specified output order of the original data, the screen-information generating unit 132 generates input screen information displayed on the display panel 15b (step S3). Available output formats are displayed, for example, as a list. FIG. 7 is an example of an input screen 400 on which a list of output formats is displayed. As shown in FIG. 7, a list screen 500 on which examples of the output formats are displayed as a list is displayed on the input screen 400.

In the MFP 10, many patterns are available as output formats. For example, in the case of a simplex standard format (e.g., one-side printed A4 portrait format), there are a plurality of sheet sizes: A3 size, A4 size, B4 size, and B5 size. However, sizes of sheets that can be stored in the MFP 10 are limited. Sizes of filing frequently used by the user are usually determined. Therefore, the number of selection items of the output formats displayed on the display unit 15 is not so large. The items of the output formats can be attached with flags indicating propriety of display such that only necessary ones can be displayed. The screen-information generating unit 132 displays only output formats permitted to be displayed by the setting on the display unit 15 as selected items.

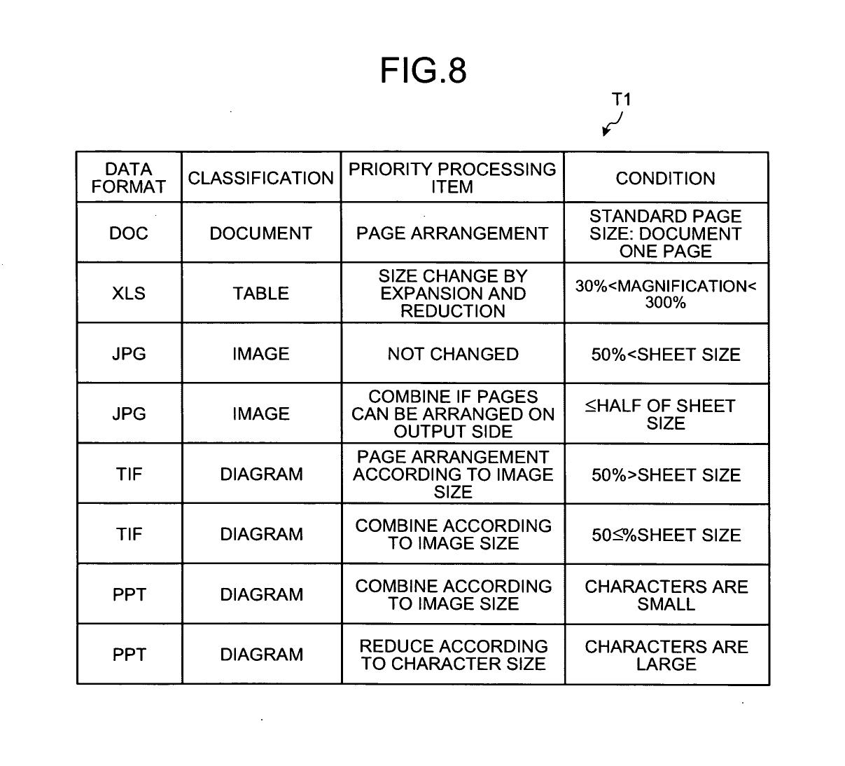

In such a state, the system control unit 16 receives input of an output format selected by the user through the display control unit 151 (Yes at step S4). The data analyzing unit 22 performs data analysis processing on the original data stored in the data storage unit 21 (step S5). In the data analysis processing, a conversion table T1 as shown in FIG. 8 is used for, for example, print size and arrangement of printing side. The conversion table T1 is used to select a priority processing item for adjusting original data to the simplex standard format (e.g., one-side printed A4 portrait format) according to an attribute of original data. Specifically, in the conversion table T1, priority processing items and conditions thereof are associated with data formats (extension name accompanying data). Consequently, print sizes, arrangement of printing sides, and the like of original data can be determined. In other words, the data analyzing unit 22 acquires data analysis information including priority processing items for original data and conditions of the priority processing items.

For example, a priority processing item “page arrangement” and a condition “standard page size: document one page” are associated with a data format of document data (extension: DOC). In other words, the data analyzing unit 22 searches for information accompanying the data and, when it is determined that a data format indicates document data (extension: DOC), sets “page arrangement” as a priority processing item on condition that “standard page size: document one page”.

A priority processing item “size change by expansion and reduction” and a condition “30%<magnification<300%” are associated with a data format of table data (extension: XLS). In other words, the data analyzing unit 22 searches for information accompanying data and, when it is determined that a data format indicates table data (extension: XLS), sets “size change by expansion and reduction” as a priority processing item on condition that “30%<magnification<300%”.

A priority processing item “page arrangement according to image size” and a condition “50%>sheet size” are associated with a data format of table data (extension: TIF). In other words, when the data analyzing unit 22 searches for information accompanying data and determines that a data format indicates table data (extension: TIF), the data analyzing unit 22 sets “page arrangement according to image size” as a priority processing item on condition that “50%>sheet size”. The priority processing item “page arrangement according to image size” indicates that an image is reduced in size when the size is larger than a surface to be printed, while combination printing is performed when the size is smaller than a half of the surface to be printed. When the size is slightly smaller than the surface to be printed, it is determined in advance, as a default setting, whether the image is to be printed as it is or the size is to be adjusted to the size of the surface.

In this embodiment, data analysis information for original data is stored in association with the management sequence of the original data in the data storage unit 21.

When the data analysis at step S5 is finished, the system control unit 16 reads out the data analysis information stored in association with the management sequence of the original data in the data storage unit 21 (step S6).

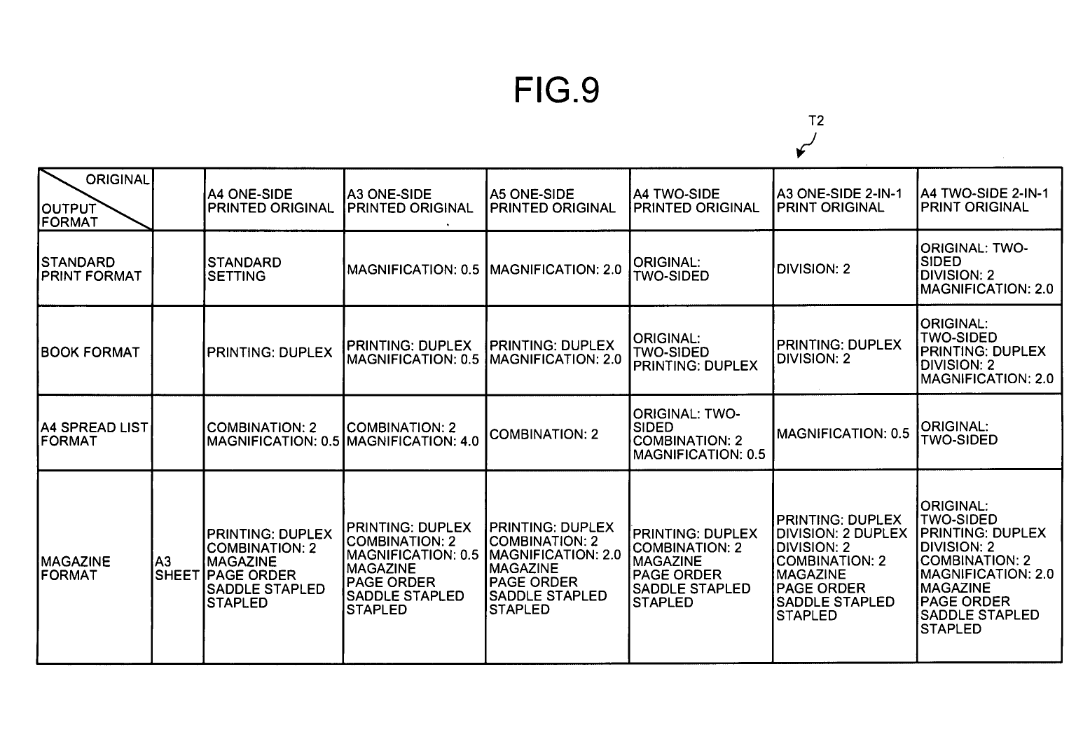

At step S7, the system control unit 16 obtains original processing setting items (VS) from the data analysis information and the output format selected by the user using, for example, a conversion table T2 as shown in FIG. 9. In the conversion table T2 shown in FIG. 9, output formats selected by the user and original formats are associated with each other. For example, when original data corresponds to an A4 one-side printed original and the user selects a book format, printing is set as “duplex”.

The system control unit 16 passes the obtained original processing setting items (VS) to the image processing unit 13 together with original data of a necessary number of pages (step S8).

Subsequently, the image processing unit 13 applies, based on the original processing setting items (VS), processing to the original data so that the original data corresponds to the output format selected by the user, and passes a processing result to the storage unit 12 (step S9).

At step S10, the preview creating unit 131 creates a preview image corresponding to the original data processed by the image processing unit 13 and stored in the storage unit 12. The screen-information generating unit 132 generates input screen information from the preview image and the original processing setting items (VS). The display control unit 151 displays the input screen information on the display panel 15b.

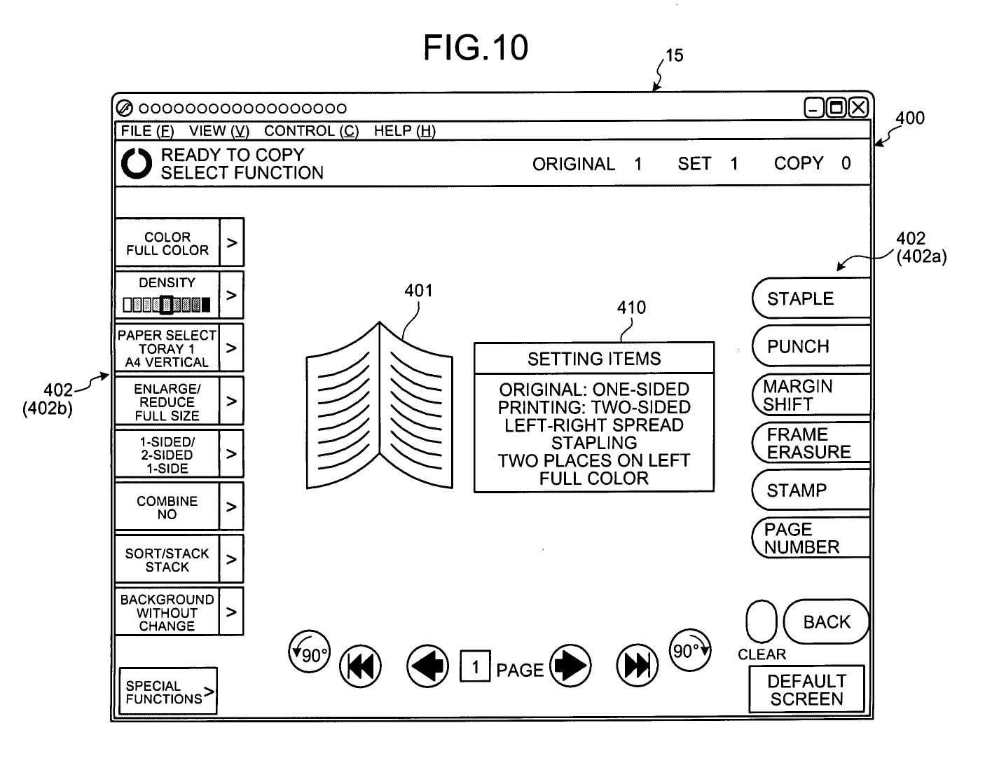

FIG. 10 is another example of the preview image. As shown in FIG. 10, in addition to the preview image 401 and the setting items 402, original processing setting items (VS) 410 is displayed on the display panel 15b. The example shown in FIG. 10 indicates that the book format is selected by the user. Consequently, in reading a set of originals at a time and performing setting processing, when setting is changed according to respective originals, page shift is possible on the preview image 401 to display the preview image 401 of the relevant page and check the original processing setting items (VS) 410 of the page. Naturally, it is possible to set processing of the page again if necessary.

The user checks whether the setting satisfies his/her requirement while viewing the preview image 401. When the user desires to add or change a setting item, the user provides an instruction for the change from the setting items 402. According to the instruction (Yes at step S11), the system control unit 16 repeats the processing at steps S6 to S10. In other words, when additional setting is specified by the user, the system control unit 16 updates the original processing setting item (VS) 410. The preview image 401 is created and displayed again.

On the other hand, when there is no such instruction and a start key (not shown) of the display unit 15 is operated (Yes at step S12), the printer controller 142 controls the printer 14 to print the processed image based on specified settings (step S13).

When the print output is finished, the system control unit 16 clears the data stored in the data storage unit 21 and the storage unit 12 (step S14).

As described above, according to the embodiment, data analysis information is generated for input original data in a plurality of formats, and the original data in the different formats are unified into selected one output format based on the data analysis information, and then output. That is, original data in different formats are automatically adjusted to a uniform format based on data analysis information related thereto. Thus, a user can obtain output of the original data in a desired format by simply selecting the format. Therefore, the user only has to pay attention to an output format, which reduces a burden on the user as well as reducing setting mistakes.

Specifically, to output (print) original data in a plurality of formats, users have been required to start an application corresponding to the original data for print setting and print instruction. However, according to this embodiment, a user can simply drag and drop original data in different formats to the MFP (image processing apparatus) 10 through the printer driver of the personal computer 100 and select an output format to output (print) the original data in the selected format.

The user can also access, from the MFP 10 having an image output function, a set of original data that the user desires to output (print) in a uniform output format.

When the printer function of the MFP 10 is used from the external device such as the personal computer 100, it is normal practice to use software, i.e., printer driver, for using the printer function. Generally, a printer driver used for the MFP 10 is determined in advance. Therefore, the MFP 10 and the printer driver can be regarded as being integrated. When the printer function of the MFP 10 is used, the printer driver is installed on the personal computer 100. When instructing the MFP 10 to perform printing, the personal computer 100 sends print data and a print format to the printer driver. In this regard, the MFP 10 and the printer driver can be regarded as one apparatus.

Therefore, the MFP 10 determines a print size, an arrangement of a printing side, and the like. However, the present invention is not limited to this. For example, the printer driver installed in the personal computer 100 can determine a print side, an arrangement of a printing side, and the like. More specifically, the printer driver displays the list screen 500 shown in FIG. 7 to cause the user to select an output format of output data and passes information concerning the selection of the output format to the system control unit 16 of the MFP 10.

The printer driver cannot only execute setting of an output format but also carry out a part of the functions of the data analyzing unit 22 of the MFP 10. The print data stored in the personal computer 100 sometimes has information larger than that sent to the MFP 10. Information concerning who a normal print format is set is information stored only in the personal computer 100. If such information is used, it is possible to support the functions of the data analyzing unit 22 of the MFP 10. For example, as information concerning output data obtained in the personal computer 100, there are a type of data distinguished by an extension of a file, a size of characters and the texture of an image of data in use, and the like. In particular, a size of characters in a large table created by spreadsheet software and a size of characters of an image created for a projector are sometimes substantially different when the characters are output to sheets of the same size. For example, a size of characters of data used in presentation software is set several times as large as a normal size. Usually, when characters are printed, the characters are reduced in size and then combination printing is performed. In this manner, by separately storing formats used for printing as data, it is possible to use the data as adjustment parameters when output data is mixed with output data of other applications.

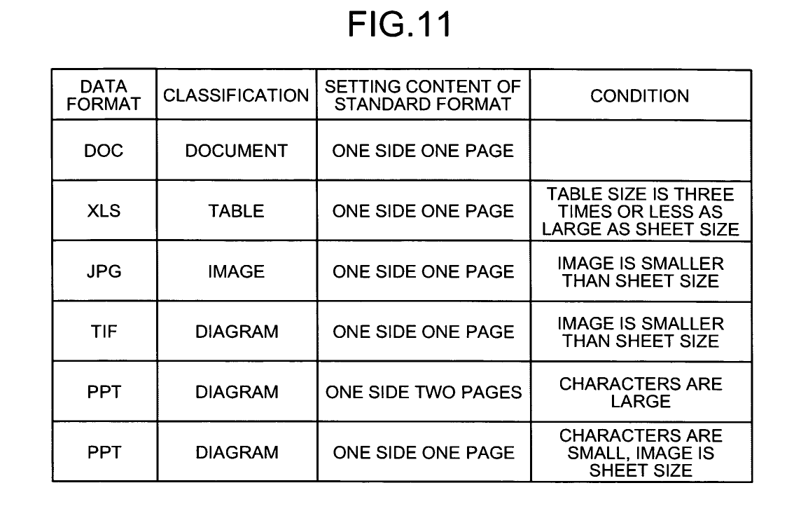

FIG. 11 is an example of an output adjustment table. In the output adjustment table, adjustment parameters in standard formats for respective data formats are stored. As shown in FIG. 11, as an output format of a standard format, it can be defined that document data (extension: DOC) for one page is printed on one side of a sheet by document software and diagram data (extension: PPT) for two pages is printed on one side of a sheet by presentation software.

When images to be output are subjected to combination printing, data fit in the standard format is arranged in one page of an combined image. For example, in the case of 2-in-1 printing, document data (extension: DOC) of two pages is output on one side of a sheet, while diagram data (extension: PPT) of four pages is output on one side of a sheet. In the case of 4-in-1 printing, document data (extension: DOC) of four pages is output on one side of a sheet, while diagram data (extension: PPT) of eight pages is output on one side of a sheet. Naturally, condition can be set such that diagram data (extension: PPT) of only one page can be output on one side of a sheet depending on the size of characters. Similarly, in the case of a table or an image, it is possible to change the number of pages arranged per a standard page according to the size of characters in use or the size of the entire table or image.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing system comprising:
an input unit that receives a set of original data in a plurality of formats;
an analyzing unit that analyzes the original data to generate analysis information for the original data;
a format display unit that selectably displays output formats for the original data;
a selecting unit that allows selection of one of the output formats;
an adjusting unit that adjusts, based on the analysis information, the formats of the original data into a uniform output format selected by the selecting unit; and
an output unit that outputs the original data in the uniform output format.

2. The image processing system according to claim 1, wherein
the analysis information associates a priority processing item for adjusting the original data to a reference format for adjusting the original data to the uniform output format with a condition for the priority processing item, and
the adjusting unit adjusts the original data to the uniform output format with a processing setting item obtained from the analysis information and the uniform output format.

3. The image processing system according to claim 1, further comprising:
a preview creating unit that creates a preview image from the original data in the uniform output format;
a preview display unit that displays the preview image, wherein
the output unit outputs, depending on content of the preview image, the original data in the uniform output format.

4. The image processing system according to claim 3, further comprising a setting unit that receives input of setting for the preview image, wherein
the preview creating unit updates the preview image based on the setting.

5. The image processing system according to claim 3, wherein the preview display unit displays the processing setting item together with the preview image.

6. The image processing system according to claim 5, wherein the preview display unit displays the priority processing item for adjusting the original data to the reference format together with the preview image.

7. The image processing system according to claim 1, wherein the analyzing unit refers to output setting for the original data in a reference format.

8. A computer program product comprising a computer usable medium having computer readable program codes embodied in the medium that, when executed, causes a computer to execute:
receiving input of a set of original data in a plurality of formats and an output format in which the original data is to be output;
analyzing the original data to generate analysis information for the original data;
adjusting, based on the analysis information, the formats of the original data into the output format; and
outputting the original data in the output format.

9. The computer program product according to claim 8, wherein
the analysis information associates a priority processing item for adjusting the original data to a reference format for adjusting the original data to the output format with a condition for the priority processing item, and
the adjusting includes adjusting the original data to the output format with a processing setting item obtained from the analysis information and the output format.

10. The computer program product according to claim 8, further causing the computer to execute:
creating a preview image from the original data in the output format;
displaying the preview image, wherein
the outputting includes outputting, depending on content of the preview image, the original data in the output format.

11. The computer program product according to claim 10, further causing the computer to execute receiving input of setting for the preview image, wherein
the creating includes updating the preview image based on the setting.

12. The computer program product according to claim 10, wherein the displaying includes displaying the processing setting item together with the preview image.

13. The computer program product according to claim 12, wherein the displaying includes displaying the priority processing item for adjusting the original data to the reference format together with the preview image.

14. The computer program product according to claim 8, wherein the analyzing includes referring to output setting for the original data in a reference format to generate the analysis information.

15. An image processing method comprising:
receiving a set of original data in a plurality of formats;
analyzing the original data to generate analysis information for the original data;
selectably displaying output formats for the original data;
selecting one of the output formats;
adjusting, based on the analysis information, the formats of the original data into a uniform output format selected at the selecting; and
outputting the original data in the uniform output format.
